(19) United States
(12) Patent Application Publication
(10) Pub. No.: US 2008/0024032 A1
(43) Pub. Date: Jan. 31, 2008

(54) Motor Stator

(76) Inventor: Toshihiko Futami, Shizuoka-Ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/628,108

(22) PCT Filed: Jun. 2, 2005
(86) PCT No.: PCT/JP05/10178

§ 371 Date: Dec. 1, 2006

(30) Foreign Application Priority Data
Jun. 21, 2004 (JP) 2004-182606

(51) Int. Cl. H02K 3/52

(52) U.S. Cl. 310/254

(57) ABSTRACT

To provide a motor stator capable of facilitating attachment of lead wire to the stator and achieving the cost reduction. The present invention provides a motor stator, wherein an insulating member is fitted to the axial end of a stator iron core, the motor stator has a winding of a conductor wire concentratedly wound around each of the pole teeth with the insulating member therebetween, so that end portions of the windings are fixed while also being electrically connected by inserting end portions of the windings in wiring receivers formed on the insulating member, and attaching a press contact type terminal to the recess of wiring receiver, and a lead wire terminal is coupled to the press contact type terminal to connect it with a lead wire, and wherein winding start and winding end of the winding are each fixed together while both winding start and winding end of the winding are also electrically connected to the press contact type terminal by inserting the winding start and the winding end of the winding of a single conductor wire in a single wiring receiver and attaching a single press contact type terminal to the wiring receiver.

### BACKGROUND OF THE INVENTION

1. Field of the Invention

The present invention relates to a motor stator, in which a press contact type terminal is attached to a wiring receiver on the insulating member fitted to the axial end of a stator iron core, and end portions of a winding are connected to lead wires via the press contact type terminal.

2. Related Art

Conventional motor stator of this type is disclosed which is provided with a plurality of wiring receivers at spaced intervals on the same circumference of the axial end of an insulating member and the base end portion of a press contact type terminal is attached to each wiring receiver so that the end portions of the winding are fixed while the end portions of the winding are also electrically connected to the press contact type terminal, and furthermore, the end portions of the winding are connected to lead wires by attaching an annular terminal plate which contains lead wires in a groove formed in the circumferential direction onto the end surface of the insulating member from which the ends of press contact type terminals protrude (for example, refer to Japanese Patent Laid-Open No. 2001-314055).

The above mentioned motor stator has a problem of complicated process of attachment of lead wires to the stator, because it needs a process of drawing a conductor wire in circumferential direction while pushing it into the groove on the terminal plate, in addition to concentratedly winding the conductor wire around the pole teeth, and furthermore, the increased cost cannot be avoided due to the separate terminal plate from the motor stator main body.

The present invention has been made to solve the aforementioned problems and an object thereof is to facilitate the attachment of lead wire to the stator and to provide a motor stator capable of reducing cost.

### SUMMARY OF THE INVENTION

To achieve the aforementioned objects, the invention according to claim 1 is characterized by providing a motor stator, wherein a frame-shaped insulating member is fitted to the axial end of a stator iron core having a plurality of pole teeth, the motor stator has a winding of a conductor wire concentratedly wound around each of the pole teeth with the insulating member therebetween, a wiring receiver is formed on the insulating member and the winding receiver has a recess in which an end portion of the winding can be inserted across an edge portion thereof, so that the end portion of the winding is fixed while also being electrically connected by attaching a press contact type terminal to the recess, and a lead wire terminal is coupled to the press contact type terminal to connect it with a lead wire, and wherein a winding start and a winding end of the winding are each fixed together while both the winding start and the winding end of the winding are also electrically connected to the press contact type terminal by inserting the winding start and the winding end of the winding of a single conductor wire in a single wiring receiver and attaching a single press contact type terminal to the wiring receiver.

The present invention can provide a motor stator which facilitates the attachment of lead wire to the stator and is capable of reducing cost by configuring it as mentioned above.

### BRIEF DESCRIPTION OF THE DRAWINGS

FIG. 1 is a plan view of a first embodiment configuration of a motor stator according to the present invention, with windings cut away as seen from the axial direction, showing that conductor wire for one phase is drawn;

FIG. 2 is an expanded view of the outer circumference of an insulating member, showing that conductor wires for three phases are drawn on the non-lead wire side of the first embodiment;

FIG. 3 is a plan view of the lead wire side of the first embodiment;

FIG. 4A is a perspective view showing that a press contact type terminal is attached to a wiring receiver of the first embodiment;

FIG. 4B is a side view showing that a lead wire terminal is connected to the press contact type terminal;

FIG. 4C is a plan view showing that the lead wire is in crimp contact with the lead wire terminal;

FIG. 5 is a plan view of the lead wire side of the first embodiment; and

FIG. 6 is a partial plan view of detailed configuration of the wiring receiver and the position of depressed portion of the slot of the first embodiment.

### DETAILED DESCRIPTION OF THE INVENTION

### First Embodiment

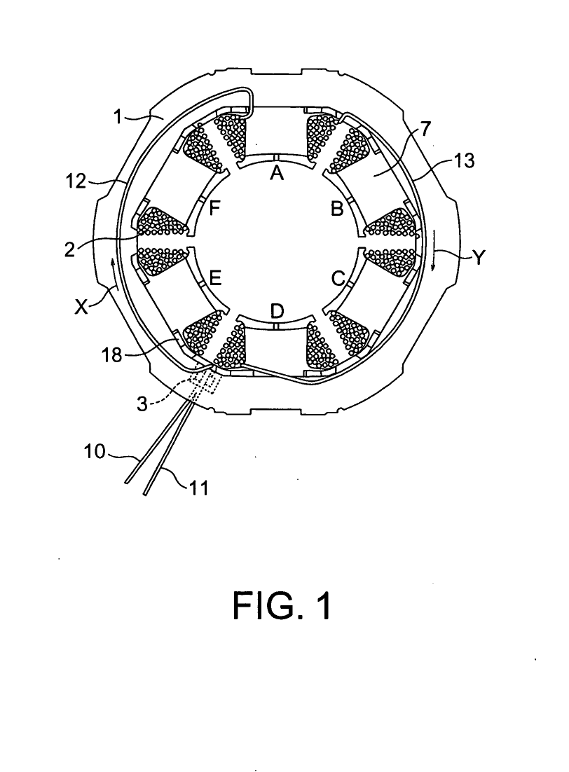

FIG. 1 is a plan view of a first embodiment configuration of a motor stator according to the present invention, with windings cut away as seen from the axial direction, showing that a conductor wire for one phase is drawn. In this figure, a stator iron core 1 is provided with six pole teeth A-F which protrude radially inward from the inner surface of a cylindrical york. A frame-shaped insulating member 7 is each fitted on the axial end of the stator iron core 1, such that a winding 2 is formed by concentratedly winding conductor wire around each pole tooth A-F with the insulating member 7 therebetween.

The insulating member 7 is provided with winding receivers 3 on the circumference thereof and further provided with flanges 18 each protruding axially at the circumferential edge corresponding to the circumferential end portion of the pole teeth A-F. Now, assuming that the backside and front side of the drawings are the lead wire side and non-lead wire side, respectively, the wiring receivers 3 are only provided on the lead wire side. And a single conductor wire is used to wind the windings 2, each having the same phase for the pole teeth A and D, pole teeth C and F, and pole teeth B and E.

Of those conductor wires, as seen from the one which is wound around the pole teeth A and D, a conductor wire whose winding start 10 of winding is inserted in the wiring receiver 3 on the lead wire side is led into the inside of the stator iron core 1 at the vicinity of the wiring receiver 3, guided to the non-lead wire side through a slot between the pole teeth D and E, and then led out of the stator iron core 1 at the end thereof.

Then, as shown with arrow X, it is drawn along the outer circumference of the insulating member 7 as a first crossover wire 12 to the slot position of the opposing pole teeth, led into the inside of the stator iron core 1, wound around the pole tooth A, and then led out of the stator iron core 1 at the end thereof on the non-lead wire side.

Then, as shown with arrow Y, it is drawn along the outer circumference of the insulating member 7 as a second crossover wire 13 to the slot position at the vicinity of the wiring receiver 3, led into the inside of the stator iron core 1, wound around the pole tooth D, and then led out of the stator iron core 1 at the end thereof on the lead wire side, such that the winding end 11 is inserted in the wiring receiver 3.

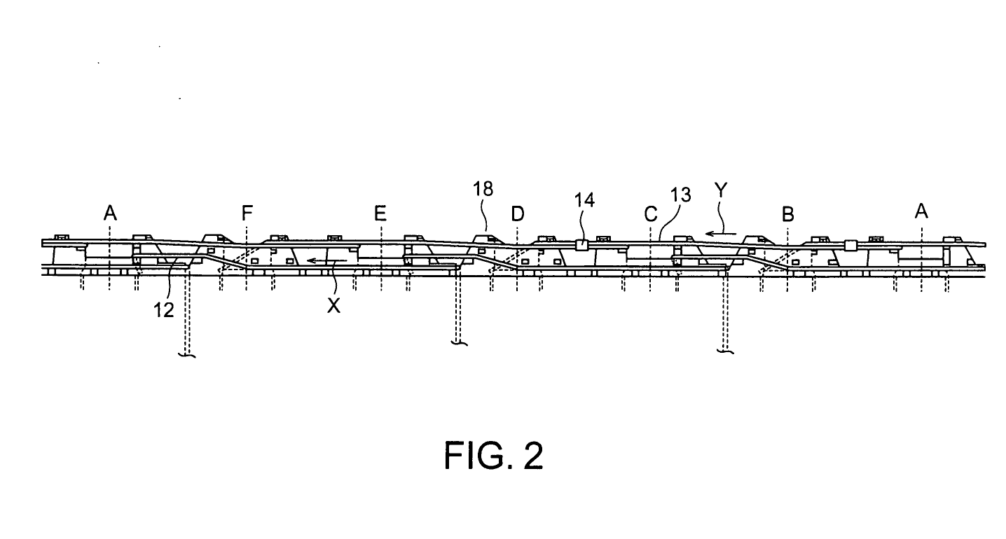

FIG. 2 is an expanded view of the outer circumference of an insulating member 7, showing that conductor wires for three phases are drawn on the non-lead wire side, and the conductor wire wound around the pole teeth A and D is led out to the stator iron core 1 at the end thereof, through the slot between the pole teeth D and E, and then as shown with arrow X, it is drawn along the outer circumference of the insulating member 7 as a first crossover wire 12 to the position corresponding to the pole tooth A, led into the inside of the stator iron core 1, and led out of the stator iron core 1 to the end thereof at the position corresponding to the pole tooth A, and then as shown with arrow Y, it is drawn along the outer circumference of the insulating member 7 as a second crossover wire 13 to the position corresponding to the pole tooth D, and led into the inside of the stator iron core 1.

Similarly, the conductor wire wound around the pole teeth C and F is led out to the stator iron core 1 at the end thereof, through the slot between the pole teeth F and A, drawn along the outer circumference of the insulating member 7 as a first crossover wire to the position corresponding to the pole tooth C, led into the inside of the stator iron core 1, and further led out of the stator iron core 1 to the end thereof at the position corresponding to the pole tooth C, drawn along the outer circumference of the insulating member 7 as a second crossover wire to the position corresponding to the pole tooth F, and led into the inside of the stator iron core 1.

Similarly, the conductor wire wound around the pole teeth B and E is led out to the stator iron core 1 at the end thereof, through the slot between the pole teeth B and C, drawn along the outer circumference of the insulating member 7 as a first crossover wire to the position corresponding to the pole tooth E, led into the inside of the stator iron core 1, and further led out of the stator iron core 1 to the end thereof at the position corresponding to the pole tooth E, drawn along the outer circumference of the insulating member 7 as a second crossover wire to the position corresponding to the pole tooth B, and led into the inside of the stator iron core 1.

Here, the first crossover wire 12 of the conductor wire wound around the pole teeth A and D has the substantially same potential as that of the winding start 10 and the winding end 11, and one phase voltage of the three-phase power supply, for example U-phase voltage, is applied as it is.

Similarly, for the first crossover wire of the conductor wire wound around the pole teeth C and F, one phase voltage of the three-phase power supply, for example V-phase voltage, is applied as it is, and similarly, for the first crossover wire of the conductor wire wound around the pole teeth B and E, one phase voltage of the three-phase power supply, for example W-phase voltage, is applied as it is.

On the other hand, for the second crossover wire 13 of the conductor wire wound around the pole teeth A and D, the second crossover wire of the conductor wire wound around the pole teeth C and F, and the second crossover wire of the conductor wire wound around the pole teeth B and E, at least two of them are in crimp contact at the neutral crimp contact position 14 (three positions shown in the figure) to become a neutral point.

Therefore, the second crossover wire, located at predetermined intervals with respect to the first crossover wire, is spaced apart from the first crossover wire in axial direction, but located at the same level mutually.

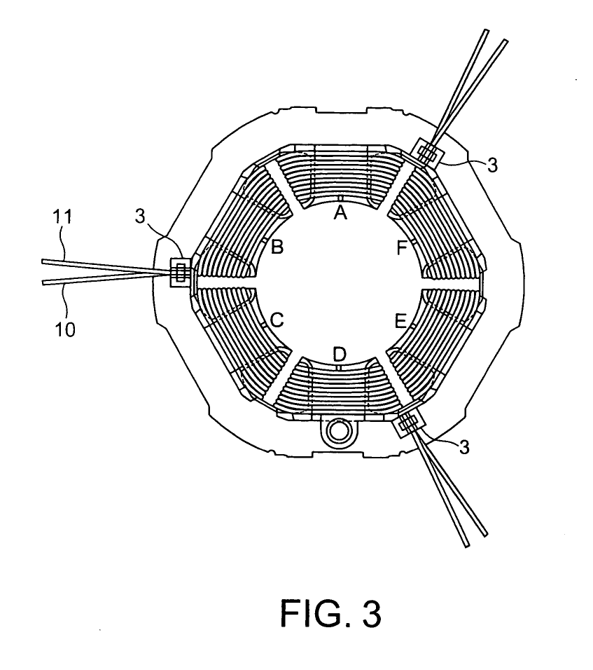

FIG. 3 is a plan view of the lead wire side of the above mentioned motor stator, and wiring receivers 3 are provided radially outside each slot between adjacent pole teeth B and C, pole teeth D and E, pole teeth F and A, and at the substantially middle position between those adjacent pole teeth. The extremities of the conductor wire which are led outwardly from the wiring receiver 3 is to be severed after the press contact type terminal is attached to the wiring receiver 3 as will be detailed below.

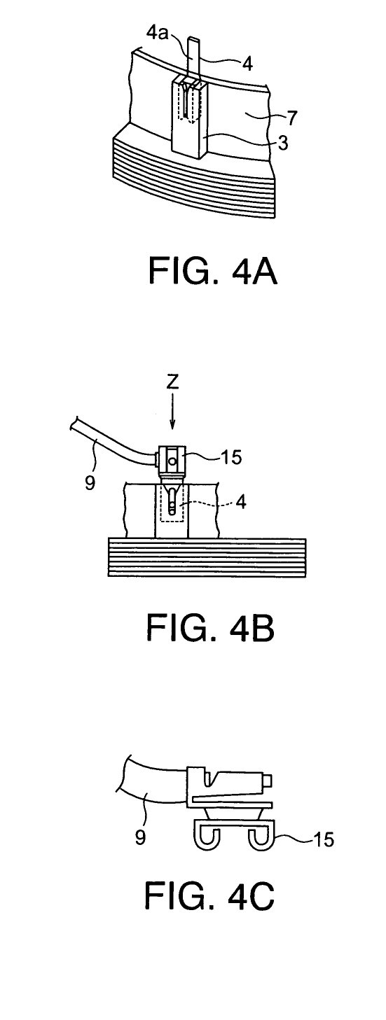

FIG. 4A is a perspective view showing that a press contact type terminal 4 is attached to the wiring receiver 3, FIG. 4B is a side view showing that a lead wire terminal 15 is connected to the press contact type terminal 4, and FIG. 4C is a plan view showing that a lead wire 9 is in crimp contact with the lead wire terminal 15.

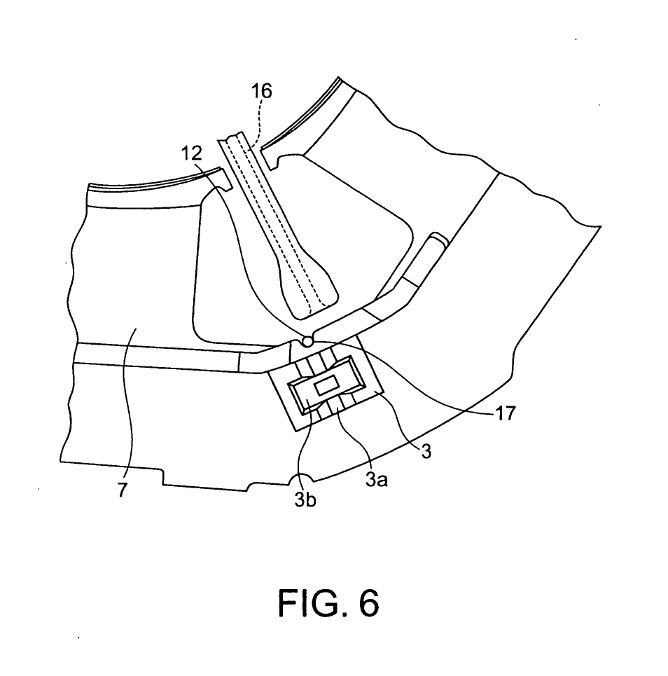

Here the wiring receivers 3 are provided on the outer circumference of the insulating member 7 on the lead wire side. The wiring receiver 3 includes a groove 3a in which an end portion of the winding can be inserted across the radial edges and a recess 3b (refer to FIG. 6 as described below), such that winding start 10 and winding end 11 are fixed while also being electrically connected, when they are superposed and inserted in the groove 3a, by attaching a press contact type terminal 4 to the recess 3b.

In this configuration, the extremities are severed. The press contact type terminal 4 includes protrusion 4a which is axially protruding, and the connection between the winding 2 and the lead wire 9 is achieved by coupling the lead wire terminal 15 having the lead wire 9 in crimp contact with it to the protrusion 4a.

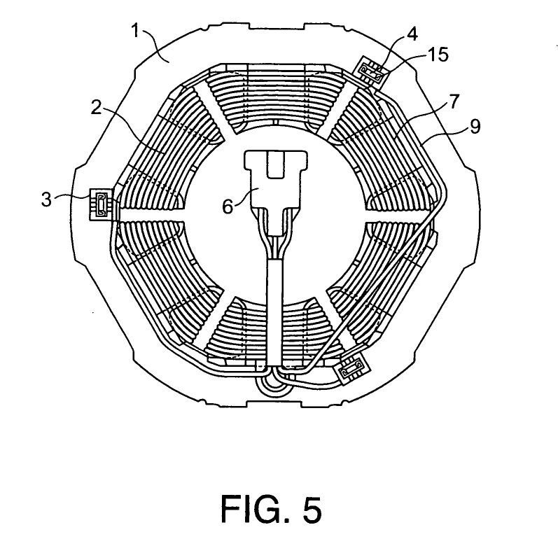

FIG. 5 is a plan view of the end surface on the lead wire side of the motor stator showing that the press contact type terminal 4 is attached to each of the three wiring receivers 3, and the lead wire terminal 15 is further coupled to the press contact type terminal 4, such that the other end of the lead wire is connected to a connector 6.

FIG. 6 is a partial plan view showing the detailed configuration of the wiring receiver 3 and the position of a depressed portion of the slot 17 formed to guide the conductor wire of the first crossover wire 12 to the non-lead wire side. In the FIG. 6, the wiring receiver 3 includes the groove 3a in which the conductor wire is inserted across the radial edges and the recess 3b to which the press contact type terminal 4 is attached, and is provided radially outside of the slot and at the substantially middle position between the adjacent pole teeth, and the depressed portion of the slot 17 is formed at the inner circumference on the extension from the groove 3a to the axial center.

With reference to the FIG. 6, the winding process is briefly described as the conductor wire which is led out of three winding nozzles 16 each located at the slot positions equally divided by three in circumferential direction is first inserted into the grooves 3a, guided to the non-lead wire side through the depressed portion of the slot 17, and then led out of the stator iron core 1 at the end thereof.

Next, it is drawn along the outer circumference of the insulator member 7 to the slot position of the opposing pole teeth, led into inside of the stator iron core, wound around the first pole teeth, and then led out of the stator iron core 1 at the end thereof on the non-lead wire side.

Then, it is drawn along the outer circumference of the insulator member 7 to the slot position in the vicinity of the wiring receiver, led into inside of the stator iron core, wound around the second pole tooth, and then led out of the stator iron core 1 at the end thereof on the lead wire side, resulting in that the end portion led out is inserted into the wiring receiver 3 as the winding end.

Thus, according to the first embodiment, fixing the ends of winding in conjunction with the winding process is possible, and after that, only the process for attaching the press contact type terminal 4 and coupling the lead wire terminal 15 is necessary, thereby eliminating the terminal plate described in the description of related art and also automating the process for forming lead wire, therefore the facilitation of the attachment of lead wire to the stator and reduction of the cost can be achieved.

Also, according to this embodiment, the first crossover wires are spaced at intervals from each other so as to prevent conductor wires with a large potential difference therebetween from being in contact with each other, therefore the reliability can be improved.

Furthermore, slot is configured to have a depressed portion at the middle in the circumferential direction so that conductor wire is inserted from the lead wire side to the non-lead wire side, thereby eliminating the interference with a nozzle and ensuring a good winding of the conductor.

### Second Embodiment

In the first embodiment, the depressed portion of the slot 17 is provided only on the inner circumference of the insulating member 7, however it may lead the strength of the insulating member 7 to be reduced due to some extremely thinned portions.

Therefore, the projections can be provided on the outer circumference at the position where the depressed portions of slots 17 are formed so as to make the thickness of insulating member 7 even, and furthermore, depressed portions can also be provided on the stator iron core 1 itself for accommodating those projections, in order to ensure the strength and improve the reliability.

### INDUSTRIAL APPLICABILITY

A motor stator according to the present invention contributes to facilitation of the process and reduction of the cost in manufacturing the stator of motor used for household electric appliance including air conditioner.

What is claimed is:

1. A motor stator, wherein a frame-shaped insulating member is fitted to the axial end of a stator iron core having a plurality of pole teeth, the motor stator has a winding of a conductor wire concentratedly wound around each of said pole teeth with said insulating member therebetween, a wiring receiver is formed on said insulating member and said winding receiver has a recess in which an end portion of the winding can be inserted across an edge portion thereof, so that said end portion of the winding is fixed while also being electrically connected by attaching a press contact type terminal to said recess, and a lead wire terminal is coupled to said press contact type terminal to connect it with a lead wire, and wherein a winding start and a winding end of the winding are each fixed together while both said winding start and said winding end of the winding are also electrically connected to said press contact type terminal by inserting said winding start and said winding end of the winding of a single conductor wire in a single said wiring receiver and attaching a single said press contact type terminal to said wiring receiver.

2. The motor stator according to claim 1, wherein when one of the axial ends of said stator iron core is defined as a lead wire side and the other is defined as a non-lead wire side, said conductor wire whose winding start of the winding inserted in said wiring receiver on said lead wire side is led into the inside of said stator iron core at the vicinity of said wiring receiver, guided to said non-lead wire side through a slot between said pole teeth, then led out of said stator iron core at the end thereof, drawn along the outer circumference of said insulating member to a slot position substantially opposing said slot, led into the inside of said stator iron core, wound around a first said pole tooth, then led out of said stator iron core at the end thereof on said non-lead wire side, drawn along the outer circumference of said insulating member to a slot position in vicinity of said wiring receiver, led into the inside of said stator iron core wound around a second said pole tooth, then led out of said stator iron core at the end thereof on said lead wire side, and the end led out of the conductor wire is inserted in said wiring receiver as the winding end of the winding.

3. The motor stator according to claim 1, wherein said wiring receiver is provided radially outside said slot and provided at the substantially middle position between adjacent said pole teeth.
